(19) United States
(12) Patent Application Publication
(10) Pub. No.: US 2013/0068743 A1
(43) Pub. Date: Mar. 21, 2013

(54) Method for controlling at least one control variable of a tool and the tool

(71) Applicant: Dritte Patentportfolio Beteiligungsgesellschaft mbH & Co. KG, Schoenefeld/Waltersdorf (DE)

(72) Inventors: Marcus DELIN, Ellerau (DE); Normen FUCHS, Rostock (DE)

(73) Assignee: Dritte Patentportfolio Beteiligungsgesellschaft mbH & Co. KG, Schoenefeld/waltersdorf (DE)

(21) Appl. No.: 13/622,011

(22) Filed: Sep. 18, 2012

(30) Foreign Application Priority Data
Sep. 20, 2011 (DE) 102011053799.6

(51) Int. Cl. B23K 9/10

(52) U.S. Cl. 219/130.01

(57) ABSTRACT

A hand-held tool and tool control includes: an orientation determination unit, which is configured to determine an orientation of the tool as orientation data or orientation-specific data, an output unit, which is operatively connected to the orientation determination unit and can transmit data to the tool control via an interface suitable for communication, wherein the orientation determination unit and/or the output unit is suitable for determining at least one control parameter, in particular a multitude of control parameters, after comparing the orientation data or the orientation-specific data to comparison variables, it being possible to transmit the at least one control parameter to the tool control for controlling the tool.

### BACKGROUND OF THE INVENTION

The invention relates to a hand-held tool and tool control, a tool orientation unit suitable for cooperating with a tool control of a hand-held tool, and a method for determining at least one control variable of a hand-held tool comprising a tool control.

A large number of tools for domestic and industrial use allow for flexible open-loop control by way of a tool control, in such a way that the operating properties of the tool can be suitably adapted to the requirements of the work process. Such adaptations of the tools are typically carried out by manual selection on the tool control, and allow the operating properties of the tool to be suitably set. For example, in a manual welding process the welder has control via a welding source control, by, for example, the necessary values for welding current, welding voltage and wire feed being set before the start of the work. Similarly, the operating properties of a joining tool, spraying tool or drilling and milling tool can be selected in advance by the worker.

If it is necessary to suitably adapt the operating properties of the tool during the work process, the work is typically interrupted and the necessary settings are made. In order to prevent an undesirably long interruption, a large number of tool controls allow control variables or control parameters to be adapted by remote controls or a remote-controlled controls. However, remote-controllable devices of this type additionally have to be carried with the tool or the tool control and therefore processing and operation become more complex. To overcome this drawback, some tool controls also make possible integrated remote control, suitable settings still being made manually by the worker. Although in embodiments of this type no additional control units have to be carried, there is still, at least for a short period of time, an interruption of the work flow while the worker makes the necessary settings.

The control parameters to be set by the worker are influenced, for example in the case of manual welding, by the material to be welded, the material thickness, the gap width, the seam configuration and the seam preparation and welding position. In this case, manual setting is typically limited to a suitable selection of the welding current, the welding voltage, the wire feed speed, the flow of gas and different pulse properties of current or voltage, if these are supported by the manual welding process. In order for it to be possible to suitably set these control variables or control parameters, the material initially has to be known to the worker in order for it to possible for the welding wire and the welding gas to be suitably selected. Furthermore, the worker typically has experience of the geometric control parameters of the welding task. In this regard, the worker has to pay attention in particular to the orientation of the tool, for example the welding gun, since different geometric orientations of the welding gun have varying requirements in terms of control parameter selection. If, in the case of manual welding, a frequent transition between different geometric welding positions is necessary during the work task or welding task, the total working speed is considerably reduced, since at each transition different control parameters have to be manually loaded or set by the worker.

European Patent Publication No. EP 1 812 200 B1 discloses a welding device in which the position of the welding head or changes in the position of the welding head are to be detected by sensors. In this manner, it is possible to influence parameters of the welding process by the detected position or change in position with reference to the values thereof. Controls are also provided which detect the position of the working head or changes in position of the working head based on output signals of the sensors and influence the process as a function of position parameters. In this case, changes in a position or rotational position of a control unit are specifically transmitted to a control apparatus. The control apparatus determines a parameter of the welding process from the transmitted change in position or rotational position. Overall, the welding process can be made safer and simpler by EP 1 812 200 B1, however the device according to EP 1 812 200 B1 is still found to be complex, in particular in respect of construction.

It is therefore desirable to provide suitable open-loop or closed-loop control of control variables which make it possible to set or adapt the tool control to different geometric working requirements in an improved manner. In particular, it should be possible to set control variables or control parameters in a simple manner.

### BRIEF SUMMARY OF THE INVENTION

In particular, a hand-held tool and a tool control include the following: an orientation determination unit, which is configured to determine an orientation of the tool as orientation data or orientation-specific data; an output unit, which is operatively connected to the orientation determination unit and can transmit data to the tool control via an interface suitable for communication, wherein the orientation determination unit and/or the output unit is suitable for determining at least one control parameter, in particular a multitude of control parameters, after comparing the orientation data or the orientation-specific data to comparison variables, it being possible to transmit the at least one control parameter to the tool control for controlling the tool.

Further, a tool orientation unit which is suitable for cooperating with a tool control of a hand-held tool, preferably suitable for cooperating with a tool control of a hand-held tool corresponding to the above-described tool and tool control, includes the following: an orientation determination unit which allows the orientation of a tool to be determined as orientation data or orientation-specific data; an output unit which is operatively connected to the orientation determination unit and can output data, the output taking place via an interface of the output unit which is suitable for being connected to an interface of the tool control, in particular an interface for communicating with external apparatuses of the tool control, wherein the orientation determination unit and/or the output unit is suitable for determining at least one control parameter after comparing the orientation data or the orientation-specific data to comparison variables, it being possible to transmit the at least one control parameter to the tool control for controlling the tool.

The invention further provides a method for determining at least one control variable of a hand-held tool including a tool control, in particular of the above-described type. The method includes the following: determining at least one orientation of the tool in space as orientation data by way of an orientation determination unit; determining at least one control parameter of the tool after comparing the orientation data or the orientation-specific data to comparison variables by way of the orientation determination unit; transmitting the at least one control parameter to the tool control by way of an output unit, which is operatively connected to the orientation determination unit, via an interface suitable for communication.

An essential aspect of the invention is that the tool includes an orientation determination unit which can not only determine and transmit orientation data, but at the same time can also convert the orientation data or corresponding orientation-specific data into at least one control parameter. In this way, the open-loop control of the respective process, for example the welding process, is simplified overall. In terms of construction, the tool including the tool control is also configured to be comparatively simple, in that the at least one control parameter (control variable) is already determined in the orientation determination unit. An upgrade of, for example, an existing control apparatus is therefore not (necessarily) needed. This improves in particular the capacity for retrofitting existing tools comprising tool controls.

The orientation determination unit can therefore preferably determine at least one control parameter. It is particularly preferred if the orientation determination unit can determine a multitude of control parameters or programs (such as welding programs) having a multitude of control parameters, in such a way that these can be transmitted to the control apparatus. It is therefore certainly conceivable that entire programs are controlled in the tool (for example in a welding machine). These programs can, if necessary, include a multitude of (e.g., more than two or even more than five) parameters. Possible parameters are in particular a (welding) current, a (welding) voltage, a wire feed speed, a flow of gas and/or different pulse properties (for example pulse frequency, pulse width) of the current and voltage (if these are supported by the method).

“Orientation-specific data” should be understood in particular to mean data which is derived from (measured) orientation data (for example an angular change determined from two measured orientations or the like).

In this regard, the determination of the orientation can only relate to the spatial orientation of the tool when in use, or also to the spatial orientation together with further inclination or rotation settings, which allow the position of a tool to be defined exactly and unambiguously in space. For simpler and less demanding work tasks, it is however already sufficient to determine the orientation of the tool in the sense of a spatial position with reference to a predetermined coordinate system or with reference to a predetermined reference vector. Accordingly, it may already be sufficient to define the orientation of a tool merely by way of an angular value which determines the deviation of a position vector defining a current work position in comparison to a temporally predetermined position vector, in particular a reference vector.

Owing to the orientation data thus determined, the geometric orientation of the tool in space can be detected, which orientation then allows control variables or control parameters of the tool to be suitably determined. Said control parameters are values which can be directly interpreted or converted by the tool control. For this purpose, in comparison, control variables can also include values which still require further processing first, before they can be converted by the tool control.

According to the invention, the data (control parameters) are transmitted via an interface of the tool control suitable for communication. The output unit also includes a suitable interface which is suitable for being communicatively connected to the interface of the tool control. An interface of this type of the tool control can for example be a remote control interface or any other suitable interface via which the data can be transmitted. In particular, the data is transmitted via an interface for reciprocal communication.

If the orientation data or the orientation-specific data are compared to suitable comparison variables, suitable control variables of the tool or control parameters of the tool can be determined in such a way that it is possible to suitably set the tool operation in terms of open-loop control. As a result, suitable open-loop control of the tool can take into account the geometric requirements which are defined by the orientation determination unit by way of the orientation data, and therefore can contribute to an improved result of the work. The present invention does not require manual setting and therefore also does not require any interruption of the work process in terms of operation and therefore ensures a more efficient work flow. In this regard, the at least one control variable of the tool or the control parameters can be determined by the orientation determination unit and/or the output unit. It is essential that the relevant determination directly or indirectly takes into account the geometric work position, determined as orientation data, of the tool. Accordingly, it is possible to completely independently set or load the control variables or control parameters.

A further evident essential point of the present invention is that the data are transmitted to the tool control via an interface suitable for communication. As a result, a tool control comprising a tool orientation unit can be retrofitted and therefore makes it possible for at least one control variable or control parameters to be suitably set or determined as a function of the orientation of the tool. A tool control can be retrofitted with an external interface or an internal interface of the tool control. Tool controls which are not equipped with an orientation determination unit can therefore also be extended in a modular manner, in such a way that they can be adapted to geometrically demanding work operations.

The orientation determination unit and/or the output unit is suitable for determining control parameters, in particular at least one control variable, which can be transmitted to the tool control for controlling the tool. The orientation determination unit and/or the output unit therefore provide, comparable to superordinate open-loop or closed-loop control of the tool control, at least one control variable or control parameters, which can be processed for controlling the tool by way of the tool control. Computationally intensive processing of the orientation data which has been determined by the orientation determination unit can therefore be prevented. Preferably, the output unit and tool control communicate on the basis of a predetermined communication protocol. If the orientation determination unit and/or the output unit are adapted to this protocol, the at least one control variable or the control parameters can be transmitted to the tool control in a particularly advantageous manner.

In a preferred embodiment, the orientation determination unit and the output unit form a common module (which is formed separately from a control apparatus or a tool control) or are components thereof. The module can be accommodated in a common housing (or can comprise a housing of this type). Furthermore, the module which is made up of the orientation determination unit and the output unit can be connected to the tool control or the hand-held tool. In one specific embodiment, the module is connected to the tool control or attached thereto. Owing to the modular configuration (as a constructional unit or assembly) of the orientation determination unit and/or the output unit, the tool including the tool control can be further simplified in terms of construction. The capacity for modification or upgrading is improved. Overall, costs can be reduced.

In a further preferred embodiment, the orientation determination unit comprises a storage device and is configured to document a dependency between at least one control parameter and the orientation data, in particular work positions or welding positions. In this way, a relationship between orientation data, control parameters and the result of the work can be documented and evaluated. This can also improve the open-loop control of the tool. For example, it can be checked whether or not the determined control parameters with a certain orientation or work position of the tool have led to a satisfactory result of the work. In the case of a negative assessment, a readjustment can be easily carried out. In particular, the result of the work, for example of a welded connection between two bodies, can be made more secure.

According to a further embodiment of the tool according to the invention and the tool control, the output unit is suitable for transmitting to the tool control parameters, in particular at least one control variable, which are/is adapted to a communication protocol of the tool control. A communication protocol of this type makes easier the extension of the tool control by way of the orientation determination unit and/or the output unit and prevents communication problems. Furthermore, a simple extension is also possible in the sense of the plug-and-play principle.

According to a further embodiment of the tool according to the invention and the tool control, the orientation determination unit and/or the output unit as superordinate closed-loop control are connected upstream of the tool control. Said closed-loop control can take place with reference to predetermined control variables or predetermined control parameters, or can also relate to the entire scope of control. For executing the closed-loop control, data are transmitted to the tool control via the output unit and are received and converted by the tool control in predetermined time slots, in particular in cyclical time slots, by the tool control. It is possible to transmit the at least one control variable or the control parameters. The superordinate closed-loop control therefore makes possible a suitable continuous closed-loop control of the tool by way of the tool control. Alternatively, superordinate open-loop control for controlling the tool control is also conceivable.

According to a further aspect of the present invention, the orientation determination unit and/or the output unit includes an optionally analogue or digital controllable potentiometer which allows the at least one control parameter for the tool control to be set.

According to a further preferred embodiment of the tool according to the invention and the tool control, the orientation data or orientation-specific data are determined relative to a reference value. In particular, determination is carried out relative to a reference value by way of a controllable potentiometer. Deviating from absolute determination of a reference value, which is for example carried out by orientation data or orientation-specific data being directly predetermined, determination relative to a reference value allows a base value to be defined before the start of a work process, and with reference to said base value, all further orientation data or orientation-specific data are determined. If, for example, a control variable or control parameter is specified as 100% as a base value for an orientation before the start of a work process, the relevant control variables or control parameters can be changed relative to this base value in the case of further changes to the orientation data. A percentage change therefore takes place which does not require any further calculation processes. In the case of a welding tool, for example, carrying out welding in a horizontal position using only 50% to 60% of the welding current or welding voltage in comparison to an overhead position thus proves to be technologically meaningful. If the welding tool is changed from an overhead position, which for example can be defined as a basic position, that is to say can be defined as a base value, the welding voltage or welding current can be determined as a suitable control parameter relative to this base value as a reference value. Determination relative to a reference value is a very advantageous embodiment of the tool comprising a tool control.

In one expedient implementation, for example, a preset control voltage as a reference value decreases or increases the voltage as a function of the tool orientation via a controllable potentiometer. A preset of this type can for example be carried out by a remote control or also can already be integrated into the tool control. Depending on the embodiment, it is possible for the worker to predetermine one or more base values as a reference value, between which base values a suitable interpolation is carried out if the orientation of the tool has changed.

In particular, the determination of orientation-specific data or at least one control variable relative to a reference value is possible with reference to predefined orientation regions, preferably angular ranges which define the orientation. In the case of a welding tool, for example, sub-division according to the welding positions PA, PB, PC, PD and PE defined in DIN EN ISO 6947 can thus be carried out. Each orientation region is for example thus allocated a predetermined relative value, in such a way that when a predetermined tool orientation is reached, the orientation-specific data or at least one control variable can be determined relative to these values.

According to a further preferred embodiment of the invention, the orientation-specific data or the at least one control variable are output in a relative value generation unit as relative variables which increase or decrease by a certain percentage a set value predetermined by the tool control in such a way that the orientation determination unit and/or the output unit increases or decreases by a certain percentage an incoming set signal predetermined by the tool control as superordinate closed-loop control, using the relative variable of the relative value generation unit and delivers said signal once more to the tool control.

According to a further embodiment, the reference value is transmitted via the interface to the orientation determination unit and/or the output unit. The reference value is therefore predetermined by the tool control. Alternatively, it is also conceivable for the reference value to be determined by the orientation determination unit and/or the output unit. However, if the reference value is determined by the tool control, it advantageously also has further other functions of the tool control available and can be further suitably processed thereby. Therefore, it is only necessary to generate relative values for this reference value in the orientation determination unit and/or output unit in order to supply said value to the tool control again for suitably controlling the tool.

According to a further embodiment of the tool according to the invention and the tool control, the reference value is fixedly predetermined by the orientation determination unit and/or the output unit. An embodiment of this type is advantageous in particular if the interface of the tool control does not allow the reference value to be transmitted to the output unit or the orientation determination unit.

According to a further particularly preferred embodiment of the present invention, the interface is suitable for communicating with external apparatuses, and in particular includes a remote control interface. It should be stated here that the term “remote control” in this document merely refers to the possibility of setting different control variables or control parameters, and does not however include closed-loop control in the sense of closed-loop controlled, continuous loading as a function of a predetermined variable. Remote control thus literally always refers to open-loop control, which according to terminology conventions is identified as remote control in particular in the field of welding tools. Nevertheless, a remote control interface according to the present embodiment makes it possible for control variables and control parameters to be transferred to the tool control in such a way that closed-loop control of the open-loop control of the tool is possible by way of external and thus superordinate closed-loop control. According to the embodiment, the interface for communicating with external apparatuses allows data to be continuously transmitted via the remote control interface, which data are also translated into suitable control parameters by the tool control in continuous intervals.

According to a further preferred embodiment of the tool according to the invention including a tool control, the tool control or the orientation determination unit includes a positioning unit or positioning support unit which allows orientation data or orientation-specific data for positioning the tool or for supporting the positioning of the tool to be processed. A positioning unit makes it possible for the worker to actively set the desired position by way of the hand-held tool. By contrast however, the positioning support unit only allows the positioning of the hand-held tool to be passively supported by the worker. Both the positioning unit and the positioning support unit are suitable for generating suitable control data, which can be communicated to further units for positioning the tool. In the case of positioning support, the worker can for example be shown whether or not a desired positioning has taken place by way of a suitable visual representation. A visual representation of this type can be carried out by way of simple light signals, or also by way of graphic representations of the tool guidance. A positioning unit can, for example, be operatively connected to active, motor-driven devices which make positioning the hand-held tool easier. Both in the case of the positioning support unit and the positioning unit, the data are generated on the basis of the orientation data or the orientation-specific data.

According to a further preferred embodiment of the invention, the orientation determination unit includes at least one sensor which allows at least one position and/or orientation of the tool to be determined. A sensor of this type can, for example, be an inclination sensor or an acceleration sensor. On the basis of the sensor data, it is possible for the orientation determination unit to determine the orientation of the tool as orientation data. Here, the sensor is expediently connected to the tool. Communication between the sensor and the orientation determination unit can, for example, take place in a wireless or also wired manner. Particularly preferably, the sensor is a three-dimensional acceleration sensor which allows accelerations to be determined in all three spatial directions. Here, the sensor is also provided for retrofitting the tool or the tool control, in the same way as the orientation determination unit and/or the output unit.

According to a further embodiment of the invention, the present tool is a welding tool. Alternatively, the tool can also be a joining tool or a drilling or milling tool or a tool for applying coatings, for example a spray gun (spray or injection tool).

According to a further aspect of the present invention, the interface of the tool control comprises an integrated bus system of a system control. A suitable bus interface is, for example, a CAN bus which makes it possible to exchange digital data.

According to a first preferred embodiment of the method according to the invention, the orientation-specific data are calculated at least in part from a comparison of first orientation data and second orientation data. A comparison of this type can refer to the orientation of the tool in space relative to a coordinate system or a fixed reference point or, however, can also include further orientation variables. For example, a comparison of first orientation data and second orientation data can also include the inclination or rotation of the tool relative to a determined position vector in space. In this case the orientation-specific data can be calculated either as vector data or angular data or can also contain still further specific variables. The orientation-specific data can also include control variables or control parameters, which can be suitably converted or processed by the tool control. For example, an angular range can thus be determined from the comparison of first orientation data and second orientation data, which range again allows a relative value for a control variable or a control parameter to be determined relative to a reference value.

According to a further aspect of the method according to the invention, the orientation data or the orientation-specific data are determined from at least one angular change of the tool in space. The angular change here typically refers to the angular discrepancy of a position vector in comparison to an earlier position vector or with a predetermined reference vector. In this case it may be sufficient to calculate merely an angular value of the two position vectors under comparison. Alternatively, two angular values in the sense of a polar angle and an azimuth angle can be determined in order for more information to be available to the tool control. Furthermore, it is possible to determine the inclination or rotation of a tool relative to a position vector. Either one angular variable or two angles are also suitable for this determination. The determination of the orientation data or the orientation-specific data from at least one angular change therefore allows a simple but also complete description of the orientation of the tool in space and is therefore sufficient for efficient open-loop control of the tool.

According to a further embodiment of the method according to the invention, communication via the interface takes place in an analogue manner. As an alternative, communication via the interface can also take place digitally. Analogue communication makes it possible, for example, to continuously change a control variable or a control parameter and, for example, allows said variables to be relatively adapted by way of a potentiometer. Digital communication only makes possible discrete communication, which can take place semi-continuously. Discrete communication is suitable in particular if only predetermined orientation regions have to be differentiated, in which different control variables or control parameters for controlling the tool are used.

According to a further embodiment of the method according to the invention, the orientation data or orientation-specific data are compared to comparison variables in analogue closed-loop control. Analogue closed-loop control allows suitable control variables or control parameters to be continuously set and therefore makes it possible for said variables to be set particularly efficiently. According to the embodiment, analogue closed-loop control of this type can also be carried out using a closed-loop control path potentiometer. The comparison variables in this case can be predetermined reference values, relative to which the control variables or control parameters are set.

According to another alternative embodiment of the method according to the invention, the orientation data or the orientation-specific data are compared to comparison variables by a comparison to stored comparison data. Comparison data of this type can be, for example, stored in a list which can be accessed during each comparison process. The comparison data are typically values of control variables or control parameters with reference to predetermined orientations or orientation regions of the tool. According to another embodiment, it is however possible to individually generate the comparison data during each comparison process.

According to a further embodiment of the method according to the invention, the orientation-specific data are determined relative to a predetermined reference value, the reference value being determined as a function of tool-specific and/or material-specific operating variables. In this case, the reference value can be specifically predetermined for the tool control or the orientation determination unit and/or output unit, or only be generated by these after input by a worker. The tool-specific and/or material-specific operating variables can also be selected by way of a menu selection on the tool control or the orientation determination unit and/or the output unit. In this case, the operating variables are already preprogrammed into the relevant components.

According to a further embodiment of the method according to the invention, the at least one control variable is determined as a function of predetermined possible orientation regions, in particular as a function of predetermined possible orientation sectors of the tool. The orientation regions or orientation sectors can be determined by predetermined angular ranges. Depending on the selection of suitable orientation data, the orientation regions may relate to predetermined value ranges or data ranges. In the case of the orientation sectors, it is particularly preferred if said sectors are defined by means of the distinction according to the welding positions PA, PB, PC, PD and PE described in DIN EN ISO 6947.

According to a further embodiment of the method according to the invention, at least one orientation of the tool is determined in space by way of a sensor. Said orientation of the tool can be determined by way of any technically suitable sensor.

In a first preferred alternative of the method, the open-loop control can take place in an analogue manner. For this purpose, orientation data (or orientation regions) and/or work positions (for example welding positions) can be defined. An (optionally automatically controllable) potentiometer can be used. Control parameters can be continuously varied. An output signal of an interface (in particular a remote control input) can act as a reference signal for the potentiometer. The adaptation of the (controllable) potentiometer can be based on a (manually set) output value (for example a 100% reference signal). The input signal or a control voltage can be automatically (percentage) controlled as a function of a tool orientation, without absolute values having to be used. Process documentation can take place (it being possible for example for a relationship between a work position, process parameters and a result of the work to be produced and documented).

In a further preferred alternative of the method, the open-loop control can take place digitally. For this purpose, orientation data (orientation regions) and a work position (for example a welding position) also can be defined. Furthermore, an angular range can be divided into sectors, for example according to a work position (welding position, for example PA-E) and the sector in which the tool is located be output (alternatively, quadrants can be defined for, for example, orbital welding). A digital (also position-dependent) control signal can be used in this case. A discontinuous (discrete) variation is made possible by digital open-loop control. Furthermore, the programming of different process parameters in combination as a parameter program is preferred. The parameter program can be selected as a function of the orientation of the hand-held apparatus. A selection can be made based on the digital control signal.

Preferred methods in which the invention is used are, for example, welding (for example, gas metal arc welding, tungsten inert gas welding or stud welding). Alternative methods are, for example, setting methods for mechanical joining elements (such as rivets, blind rivets, lockbolts and the like) or drilling.

Data transfer (for example, between the orientation determination unit and the control apparatus) can take place in a wired or wireless manner, for example, by radio or infrared. Positioning or orientation (for example, checking whether the tool is vertically positioned) can take place via a display element such as a (red-green) diode. A particularly preferred development is that of documenting the entire process with respect to the work position and/or process parameters and/or the result of the work.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 shows a first embodiment of the hand-held tool according to the invention comprising a tool control;

FIG. 2 shows a second embodiment of the hand-held tool according to the invention comprising a tool control;

FIG. 3 is a schematic representation of the determination of the orientation of the tool as orientation data according to a further embodiment of the invention;

FIG. 4 is a detailed view of the embodiment shown in FIG. 1 of the hand-held tool according to the invention comprising a tool control;

FIG. 5 is a flow diagram according to a further embodiment of the method according to the invention for determining at least one control variable of a hand-held tool comprising a tool control;

FIG. 6 is a flow diagram for representing a further embodiment of the method according to the invention for determining at least one control variable of a hand-held tool comprising a tool control;

FIG. 7 is a schematic representation illustrating the open-loop control of a control variable or a control parameter of welding open-loop control relative to a predetermined reference value;

FIG. 8a is a schematic representation illustrating different orientation sectors in analogue open-loop control by means of the tool orientation unit; and

FIG. 8b shows two possible orientation sectors according to a further embodiment of the invention.

### DETAILED DESCRIPTION OF THE INVENTION

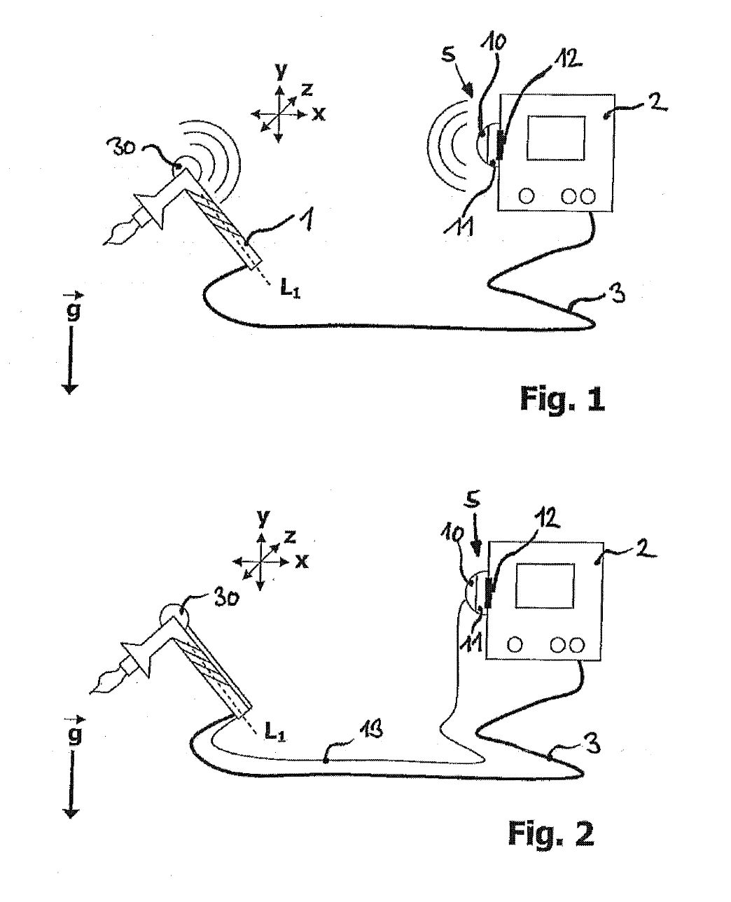

FIG. 1 is a schematic representation of a first embodiment of the hand-held tool 1 according to the invention including a tool control 2. The tool control 2 is connected to the tool 1 via a connection 3. The connection 3 can include merely an electrical connection or additional other connections, such as a gas connection. According to the present embodiment, the tool 1 is a welding gun which can be suitably controlled by a welding gun control 2 with respect to different operating states. The operating states are set in the tool control 2 by predetermined control variables or control parameters.

Furthermore, the tool control 2 includes a tool orientation unit 5 which includes an orientation determination unit 10 and an output unit 11. The output unit 11 also comprises an interface 12′ (not shown here) which is communicatively connected to a corresponding opposing interface, interface 12 of the tool control 2. Furthermore, the tool orientation unit 5 includes a sensor 30 which is rigidly connected to the tool 1. According to the embodiment, the orientation of the tool 1 can be detected as orientation data in a suitable manner by the sensor 30 and transmitted to the orientation determination unit 10. Alternatively, detection of other suitable data by the sensor 30 is also provided, which can be suitably converted into orientation data after being transmitted to the orientation determination unit 10. The orientation determination unit 10 can determine the orientation data or orientation-specific data which have been calculated from the orientation data by further processing, and can transfer control parameters determined therefrom to the output unit 11, which then transmits the control parameters to the tool control 2. The tool control 2 controls the tool 1 in a suitable manner based on the control parameters of the tool orientation unit 5. For this purpose, suitable control variables or control parameters which correspond to a suitable operating state of the tool 1 are determined from the orientation data or orientation-specific data. The control variables or control parameters can be calculated in the orientation determination unit 10 or the output unit 11.

According to the embodiment, the orientation of the tool 10 is determined relative to the direction of the gravity vector (g). Here, for example, the relative angle between the longitudinal extension L1 of the tool handle of the tool 1 is determined in comparison to the direction of the gravitational acceleration vector. The tool 1 can move freely in the whole space. Depending on the change or the relative orientation of the tool 1 to the direction of gravity, suitable data are transmitted to the orientation determination unit 10. According to the embodiment, transmission takes place wirelessly by radio contact.

According to the invention, the tool orientation unit 5 is provided as an external device of the tool control 2. The tool orientation unit 5 is connected to the tool control 2 via the interface 12 of the tool control 2. According to a further embodiment, the tool orientation unit can however already be integrated into the housing of the tool control 2. Communication between the tool orientation unit 5 and the tool control 2 can take place via a suitable internal interface 12 of the tool control 2. Furthermore, according to the embodiment, the sensor 30 is releasably attached to the tool 1, and can be attached in principle to any point on the tool 1. According to the embodiment, the sensor 30 is configured as a three-dimensional acceleration sensor 30. As an alternative, three independent one-dimensional acceleration sensors are also possible, which can measure the different acceleration components in three directions. The orientation determination unit 10 can determine suitable orientation data from the acceleration values and determines the relative angle between the direction of gravitational acceleration (g) and the longitudinal extension direction L1 of the handle of the tool 1.

FIG. 2 shows a further embodiment of the tool according to the invention including a tool control, which embodiment only differs from that shown in FIG. 1 in that communication between the sensor 30 and the tool orientation unit 5 is not wireless but wired. The data detected by the sensor 30 are supplied to the orientation determination unit 10 via a line 13. According to a further embodiment, the line 13 can also be integrated into the connection 3 between the tool control 2 and the tool 1.

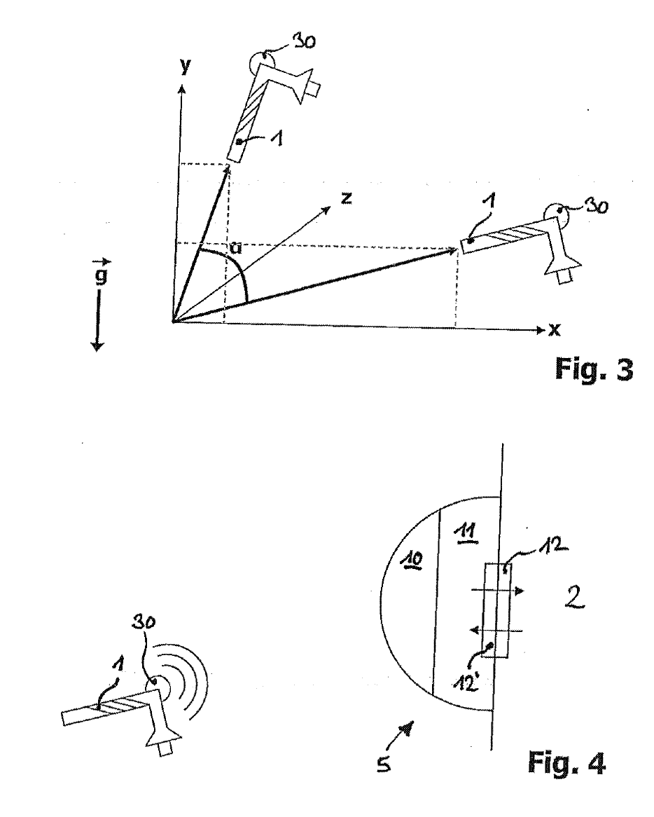

FIG. 3 is a schematic representation of the determination of the orientation of the tool 1 as orientation data in space. Here, two positions of the tool 1 are defined by two respective position vectors. The two positions differ by an angle α. The position vectors can adopt both different lengths and a different spatial direction (shown by the three-dimensional coordinate system having axes x, y and z). According to the embodiment, the orientation of the tool 1 can be determined as an angular change between the two position vectors, that is to say as angle α. Alternatively, it is also possible to determine the orientation of the tool 1 relative to the direction of the gravity vector, parallel to the y axis of the three-dimensional Cartesian coordinate system. If the position of the tool 1 is initialised at the start of the work process by it being oriented for example in a certain position with reference to the direction of the gravitational acceleration vector, the further angular changes can be determined as orientation data by the orientation determination unit 10 during the work process. The orientation data are then also used to determine suitable control variables or control parameters for the open-loop control of the tool 1, in order to achieve advantageous, orientation-dependent open-loop control of the tool 1.

FIG. 4 is a detailed view of the tool orientation unit 5 according to the embodiment in FIG. 1. For transmitting the orientation data or orientation-specific data by means of the tool orientation unit 5, that is to say by way of the orientation determination unit 10 and/or the output unit 11, an interface 12 of the tool control 2 is provided on the tool control 2. The interface 12 is communicatively connected to a further interface 12′ of the output unit 11. According to the embodiment, the exchange of data is bilateral, that is to say data can be both transmitted and received by the output unit 11. According to alternative embodiments, the interface 12 or 12′ can also be provided for solely unilateral communication. Furthermore, the communication for outputting can take place via an interface 12′ of the output unit 11 and the communication for receiving can take place by means of a further receiving unit (not shown) of the tool orientation unit 5.

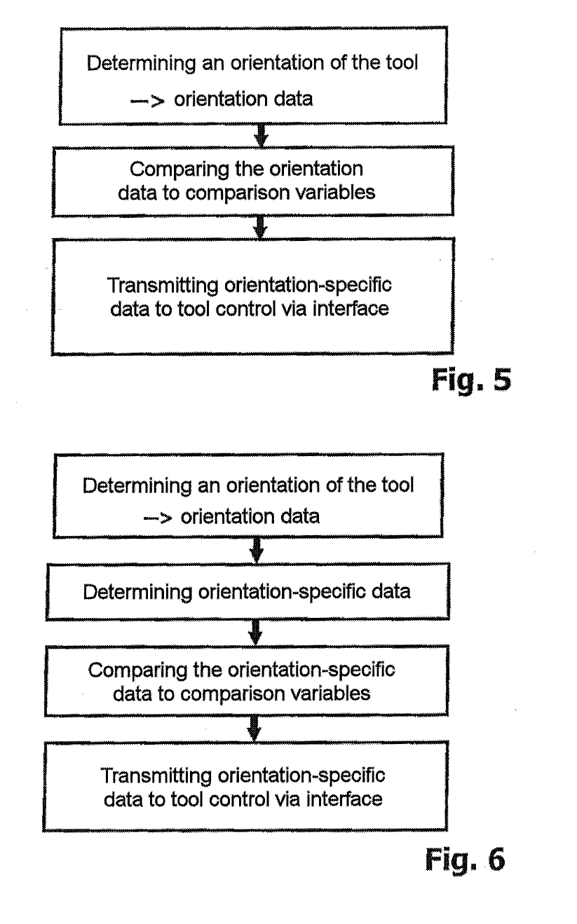

FIG. 5 shows an embodiment of the method according to the invention for determining at least one control variable of a hand-held tool comprising a tool control, in which method the orientation of the tool 1 is initially determined. Determining the orientation makes it possible to calculate or determine orientation data which are compared to corresponding comparison variables, that is to say comparison data, in a second method step. In this case a comparison can be carried out explicitly by comparing individual data values or implicitly by the orientation data being used for further processing and being able to result in different comparison results depending on orientation. For example, analogue closed-loop control can thus receive the orientation data as a control voltage and, corresponding to a characteristic curve, a further value can be output. The output value thus corresponds to the comparison result.

The comparison result or the orientation data allow the orientation-specific data to be determined, which in the present case according to the embodiment are transmitted to the tool control 2 via the interface 12 of the tool control 2.

According to a further embodiment of the method according to the invention, the orientation data can also be used for calculating orientation-specific data before comparison to comparison variables. A method of this type is schematically shown in FIG. 6 in a flow diagram. After calculating or determining the orientation-specific data from the orientation data, said data are compared to corresponding comparison variables. The comparison can again take place in the tool orientation unit 5. After a successful comparison, the control parameters determined from the orientation-specific data can be transmitted to the tool control via the interface 12 of the tool control 2 in the same form or an altered form. In the embodiments of the method according to the invention which are schematically shown in FIG. 5 and FIG. 6, at least one control variable of the tool for controlling the tool 1 is then determined.

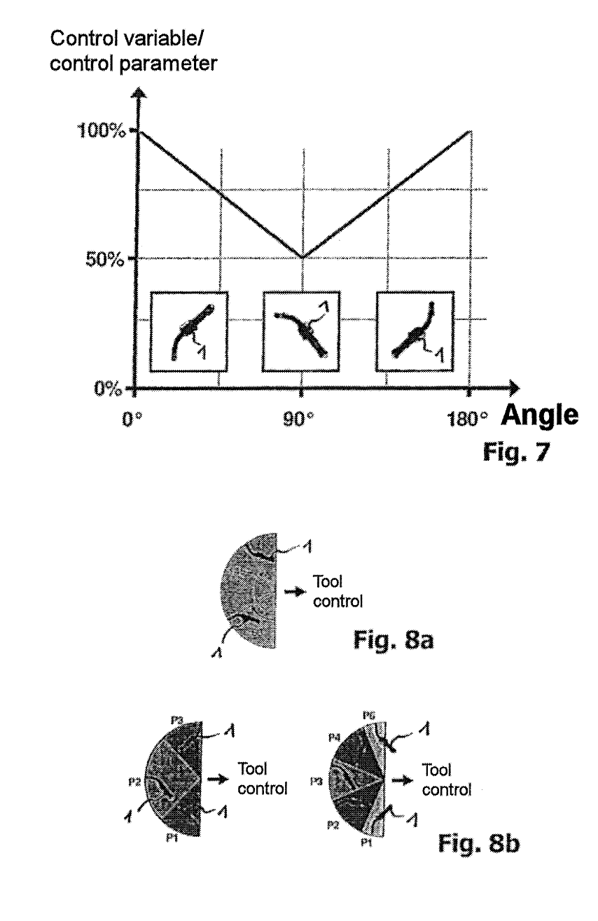

FIG. 7 is a schematic representation of the relative closed-loop control or determination of at least one control variable or control parameter in comparison to an absolute determination. In the relative determination, a base value or reference value is predetermined according to the orientation of the tool 1 in space in a starting position. In the present case, the entire reference value is predetermined as 100% in a zero-degree position. Alternatively, this value can also be predetermined in a 180-degree position of the tool 1. The angle refers to a relative deviation value between an initialisation position vector for representing the position of the tool 1 in space in comparison to the direction of the gravitational acceleration vector. The initialisation vector is not shown here. When changing the orientation to a 90° position, the relative value of the control variable or control parameters to be determined or to be controlled in a closed loop is decreased to 50% of the original value. Here, a linear interpolation can be carried out between the values. When changing the tool orientation, the value of the control variable or the control parameters is therefore changed in terms of percentage, the relative change being predetermined in the shown extreme positions (zero-degree angular position, 90-degree angular position, 180-degree angular position). Alternatively, any other type of meaningful interpolation can also take place between these extreme positions.

According to a specific embodiment, the control voltage or the control current of a welding gun can be decreased in a targeted manner from a zero-degree position (flat position, PA) to a 90-degree position (vertical position, PF, PG) by relative value determination or relative closed-loop control.

FIG. 8a is a schematic representation of continuous determination or closed-loop control of at least one control variable of the tool 1 or one control parameter by means of continuous analogue closed-loop control. Here, the orientation of the tool 1 is continuously taken from a starting 60° position into a 145° position. The change in orientation is transmitted as orientation data to the tool control 2 via the interface 12. At least one control variable or one control parameter can be changed at said tool control according to the change in orientation of the tool 1.

The discrete determination or discrete closed-loop control shown in FIG. 8b is different, providing predetermined orientation regions or orientation sectors. Depending on the orientation region or orientation sector, different control variables or parameters are determined, which make possible an advantageous configuration of the working method. The embodiment shown on the left-hand side of FIG. 8b differs for example in three sectors P1, P2 and P3. The embodiment shown on the right-hand side of FIG. 8b differs by five orientation regions or orientation sectors P1, P2, P3, P4 and P5 in total. If the orientation of the tool 1 is changed within an orientation region or orientation sector of this type, the control variable or control parameter is not changed by the tool orientation unit 5. Accordingly, continuous orientation determination of the tool 1 is not necessary, and can be replaced by discrete closed-loop control or determination instead.

At this point it should be noted that all of the above-described parts, considered alone per se and in any combination, in particular the details shown in the drawings, are claimed as essential to the invention. Amendments thereto are routine for a person skilled in the art.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A hand-held tool (1) and tool control (2) comprising:
an orientation determination unit (10), which is configured to determine an orientation of the tool (1) as orientation data or orientation-specific data,
an output unit (11), which is operatively connected to the orientation determination unit (10) and can transmit data to the tool control (2) via an interface (12) suitable for communication,
wherein
the orientation determination unit (10) and/or the output unit (11) is configured to determine at least one control parameter after comparing the orientation data or the orientation-specific data to comparison variables, the at least one control parameter being transmitted to the tool control (2) for controlling the tool (1).

2. The tool and tool control according to claim 1, wherein
the orientation determination unit (10) and the output unit (11) form a common module, the module formed from the orientation determination unit (10) and the output unit (11) preferably being connected to the tool control (2) or the hand-held tool (1).

3. The tool and tool control according to claim 1, wherein
the orientation determination unit (10) comprises a storage device and is configured to log a dependency between at least one control parameter and the orientation data, in particular welding positions.

4. The tool and tool control according to claim 1, wherein
the output unit (11) is configured to transmit to the tool control (2) at least one control variable, which is adapted to a communication protocol of the tool control (2).

5. The tool and tool control according to claim 1, wherein
the orientation determination unit (10) and/or the output unit (11) as superordinate closed-loop control are connected upstream of the tool control (2).

6. The tool and tool control according to claim 1, wherein
the orientation determination unit (10) and/or the output unit (11) comprises an analogue or digital controllable potentiometer (20) which allows the at least one control parameter for the tool control (2) to be set.

7. The tool and tool control according to claim 1, wherein
the orientation-specific data are output in a relative value generation unit as relative variables which increase or decrease by a certain percentage a set value predetermined by the tool control (2) in such a way that the orientation determination unit (10) and/or the output unit (11) increases or decreases by a certain percentage an incoming set signal predetermined by the tool control (2) as superordinate closed-loop control using the relative variable of the relative value generation unit and delivers said signal once more to the tool control (2),
the reference value being transmitted via the interface (12) to the orientation determination unit (10) and/or the output unit (11),
the reference value being fixedly predetermined by the orientation determination unit (10) and/or the output unit (11).

8. The tool and tool control according to claim 1, wherein
the interface (12) is suitable for communicating with external apparatuses, and comprises a remote control interface.

9. The tool and tool control according to claim 1, wherein
the tool control (2) or the orientation determination unit comprises a positioning unit (15) or positioning support unit (16) which allows orientation data or orientation-specific data for positioning the tool (1) or for supporting the positioning of the tool (1) to be processed.

10. The tool and tool control according to claim 1, wherein
the tool (1) is one of a welding tool, a joining tool, a drilling tool, a milling tool, or a tool for applying coatings.

11. The tool and tool control according to claim 1, wherein
the interface (12) comprises an integrated bus system of a system control.

12. A tool orientation unit configured to cooperate with a tool control (2) of a hand-held tool (1) according to claim 1, comprising:
an orientation determination unit (10) which allows the orientation of a tool (1) to be determined as orientation data or orientation-specific data,
an output unit (11) which is operatively connected to the orientation determination unit (10) and can output data, the output taking place via an interface (12′) of the output unit (11) which is configured to be connected to an interface (12) of the tool control (2),
wherein
the orientation determination unit (10) and/or the output unit (11) is configured to determine at least one control parameter after comparing the orientation data or the orientation-specific data to comparison variables, the at least one control parameter being transmitted to the tool control (2) for controlling the tool (1).

13. A method for determining at least one control variable of a hand-held tool (1) comprising a tool control (2), the method comprising:
determining at least one orientation of the tool (1) in space as orientation data by way of an orientation determination unit (10);
determining at least one control parameter of the tool (1) after comparing the orientation data or the orientation-specific data to comparison variables by way of the orientation determination unit;
transmitting the at least one control parameter to the tool control (2) by way of an output unit (11), which is operatively connected to the orientation determination unit (10), via an interface (12) configured for communication.

14. The method according to claim 13, wherein
communication via the interface (12) takes place in an analogue or digital manner.

15. The method according to claim 13, wherein
continuous control takes place by way of analogue closed-loop or open-loop control.

16. The method according to claim 13, wherein
the orientation data or orientation-specific data are compared to comparison variables by a comparison with stored comparison data.

17. The method according to claim 13, wherein
the orientation-specific data are determined relative to a predetermined reference value, the reference value being determined as a function of tool-specific and/or material-specific operating variables.

18. The method according to claim 13, wherein
the at least one control variable is determined as a function of predetermined possible orientation regions.

19. The method according to claim 18, wherein
the predetermined possible orientation regions are predetermined possible orientation sectors of the tool (1).
